(19) United States
(12) Patent Application Publication
(10) Pub. No.: US 2026/0154964 A1
(43) Pub. Date: Jun. 4, 2026

(54) METHODS AND SYSTEMS FOR MEDIA RETENTION

(71) Applicant: GENETEC INC., Saint-Laurent (CA)

(72) Inventors: Mortimer HUBIN, Laval (CA); Jonathan DOYON, Saint-Laurent (CA)

(21) Appl. No.: 18/705,153

(22) PCT Filed: Oct. 30, 2023
(86) PCT No.: PCT/CA2023/051442

§ 371 Date: Apr. 26, 2024

Related U.S. Application Data
(60) Provisional application No. 17/976,131, filed on Oct. 28, 2022.

(51) Int. Cl. G06V 20/52; G06T 7/00; H04N 7/18

(52) U.S. Cl. CPC G06V 20/52; G06T 7/0002; H04N 7/18

(57) ABSTRACT

There is provided a method for media retention in a surveillance system deployed by an organization at a location being surveilled. The method comprises obtaining media stream data generated by one or more media devices deployed at the location, assigning at least one risk score to the media stream data, determining, based on the at least one risk score, a retention policy to be applied to the media stream data, and causing the media stream data to be stored according to the retention policy.

### CROSS-REFERENCE TO RELATED APPLICATIONS

This patent application claims priority of U.S. application No. Ser. No. 17/976,131 filed Oct. 28, 2022, the entire contents of which are incorporated herein by reference.

### FIELD

The improvements generally relate to surveillance systems, and more particularly to retention of media stream data in a surveillance system.

### BACKGROUND

Surveillance systems are typically composed of a variety of different devices that generate data as a site is being surveilled. Many surveillance systems include cameras or other devices which capture media data, for instance images or video data, as well as metadata, used in performing surveillance of the site. The captured data is typically archived for various purposes, including investigation in case of an incident or compliancy to regulations. Some circumstances may however require data to be archived for extended periods of time, which can significantly increase costs for the organization operating the surveillance system.

While existing surveillance systems are suitable for their purposes, there remains room for improvement.

### SUMMARY

The following presents a simplified summary of one or more implementations in accordance with aspects of the present disclosure, in order to provide a basic understanding of such implementations, without limiting the embodiments presented within the present disclosure. While existing surveillance systems and networks are suitable for their purposes, the costs associated with storage of media generated by the surveillance system (e.g., by media devices such as cameras, microphones, etc.) are typically prohibitive. To this end, the present disclosure provides methods and systems for media retention in a surveillance system. Media stream data is generated by one or more media devices deployed on a local network, at a location being surveilled. In order to determine the manner in which to retain the media stream data, at least one risk score is assigned to the media stream data. Based on the risk, a retention policy is determined and he media stream data is stored according to the retention policy.

In accordance with one aspect, there is provided a method for media retention in a surveillance system deployed by an organization at a location being surveilled. The method comprises obtaining media stream data generated by one or more media devices deployed at the location, assigning at least one risk score to the media stream data, determining, based on the at least one risk score, a retention policy to be applied to the media stream data, and causing the media stream data to be stored according to the retention policy.

In at least one embodiment in accordance with any previous/other embodiment described herein, the surveillance system has a plurality of retention policies associated therewith, and determining the retention policy comprises selecting the retention policy among the plurality of retention policies based on the at least one risk score.

In at least one embodiment in accordance with any previous/other embodiment described herein, the retention policy comprises is determined dynamically based on the at least one risk score.

In at least one embodiment in accordance with any previous/other embodiment described herein, the method further comprises determining a probability of an investigation employing the media stream data upon occurrence of at least one event at the location.

In at least one embodiment in accordance with any previous/other embodiment described herein, the method further comprises determining a level of impact on the organization upon the occurrence of the at least one event at the location.

In at least one embodiment in accordance with any previous/other embodiment described herein, the at least one risk score is determined as a function of the level of impact and the probability of the investigation.

In at least one embodiment in accordance with any previous/other embodiment described herein, the media stream data was previously caused to be stored according to a previously-assigned retention policy, and the retention policy assigned to the media stream data based on the at least one risk score is different from the previously-assigned retention policy.

In at least one embodiment in accordance with any previous/other embodiment described herein, the method further comprises processing the media stream data for determining a content thereof, the level of impact determined based on the content of the media stream data. In at least one embodiment in accordance with any previous/other embodiment described herein, the method further comprises processing the media stream data for identifying an origin thereof, the level of impact determined based on the origin of the media stream data. In at least one embodiment in accordance with any previous/other embodiment described herein, the method further comprises receiving one or more indicators from the surveillance system, the level of impact determined based on the one or more indicators.

In at least one embodiment in accordance with any previous/other embodiment described herein, the origin of the media stream data is indicative of a given one of the one or more media devices having generated the media stream data, and the level of impact is determined based on an importance level associated with the given media device.

In at least one embodiment in accordance with any previous/other embodiment described herein, the origin of the media stream data is indicative of a geographic position of a given one of the one or more media devices having generated the media stream data, the level of impact determined based on an importance level associated with the geographic position of the given media device.

In at least one embodiment in accordance with any previous/other embodiment described herein, the content of the media stream data is indicative of a presence of at least one individual and/or asset at the location, the level of impact determined based on an importance level associated with the at least one individual and/or asset.

In at least one embodiment in accordance with any previous/other embodiment described herein, the method further comprises increasing or decreasing at least one of the level of impact, the probability of investigation, and the at least one risk score in response to at least one of a user-initiated command and a system-initiated command.

In at least one embodiment in accordance with any previous/other embodiment described herein, the media stream data comprises a plurality of media stream segments each acquired over a given timeframe, and an individual risk score is assigned to each of the plurality of media stream segments.

In at least one embodiment in accordance with any previous/other embodiment described herein, the retention policy is indicative of at least one first action to be taken on the media stream data when the at least one risk score is greater than or equal to a threshold, and of at least one second action to be taken on the media stream data when the at least one risk score is lower than the threshold.

In at least one embodiment in accordance with any previous/other embodiment described herein, the retention policy is indicative of the at least one first action comprising storing an entirety of the media stream data in target storage media, and of the at least one second action comprising thinning the media stream data to retain at least one selected portion thereof and storing the at least one selected portion in the target storage media.

In at least one embodiment in accordance with any previous/other embodiment described herein, the retention policy is indicative of the at least one first action comprising processing the media stream data to increase a quality thereof and generate a high-quality media stream data, and storing the high-quality media stream data in target storage media, and of the at least one second action comprising processing the media stream data to reduce the quality thereof and generate a low-quality media stream data, and storing the low-quality media stream data in the target storage media.

In at least one embodiment in accordance with any previous/other embodiment described herein, the retention policy is indicative of at least one action to be taken on the media stream data prior to storage thereof, the at least one action comprising processing the media stream data to modify a quality thereof and generate a modified media stream data, and storing the modified media stream data in target storage media.

In at least one embodiment in accordance with any previous/other embodiment described herein, the retention policy is indicative of the at least one first action comprising causing the media stream data to be stored in target storage media for a first time period, and of the at least one second action comprising causing the media stream data to be stored in the target storage media for a second time period lower than the first time period.

In at least one embodiment in accordance with any previous/other embodiment described herein, the media stream data is caused to be stored in at least one of cloud-based storage media and local storage media over a predetermined time period.

In at least one embodiment in accordance with any previous/other embodiment described herein, the media stream data is caused to be stored in two or more different target storage media.

In at least one embodiment in accordance with any previous/other embodiment described herein, the media stream data comprises at least one of audio data, image data, video data, and text data.

In accordance with an other aspect, there is provided a system for media retention in a surveillance system deployed by an organization at a location being surveilled, the system comprising a processing unit and a non-transitory computer-readable medium having stored thereon program instructions executable by the processing unit for obtaining media stream data generated by one or more media devices deployed at the location, assigning at least one risk score to the media stream data, determining, based on the at least one risk score, a retention policy to be applied to the media stream data, and causing the media stream data to be stored according to the retention policy.

In at least one embodiment in accordance with any previous/other embodiment described herein, the surveillance system has a plurality of retention policies associated therewith, and the program instructions are executable by the processing unit for determining the retention policy comprising selecting the retention policy among the plurality of retention policies based on the at least one risk score.

In at least one embodiment in accordance with any previous/other embodiment described herein, the retention policy is determined dynamically based on the at least one risk score.

In at least one embodiment in accordance with any previous/other embodiment described herein, the program instructions are executable by the processing unit for determining a probability of an investigation employing the media stream data upon occurrence of at least one event at the location.

In at least one embodiment in accordance with any previous/other embodiment described herein, the program instructions are executable by the processing unit for determining a level of impact on the organization upon the occurrence of the at least one event at the location.

In at least one embodiment in accordance with any previous/other embodiment described herein, the program instructions are executable by the processing unit for determining the at least one risk score as a function of the level of impact and the probability of the investigation. In at least one embodiment in accordance with any previous/other embodiment described herein, the media stream data was previously caused to be stored according to a previously-assigned retention policy, and the program instructions are executable by the processing unit for assigning the retention policy to the media stream data based on the at least one risk score is different from the previously-assigned retention policy.

In at least one embodiment in accordance with any previous/other embodiment described herein, the program instructions are executable by the processing unit for processing the media stream data for determining a content thereof, the level of impact determined based on the content of the media stream data.

In at least one embodiment in accordance with any previous/other embodiment described herein, the program instructions are executable by the processing unit for processing the media stream data for identifying an origin thereof, the level of impact determined based on the origin of the media stream data.

In at least one embodiment in accordance with any previous/other embodiment described herein, the program instructions are executable by the processing unit for receiving one or more indicators from the surveillance system, the level of impact determined based on the one or more indicators.

In at least one embodiment in accordance with any previous/other embodiment described herein, the origin of the media stream data is indicative of a given one of the one or more media devices having generated the media stream data, and the program instructions are executable by the processing unit for determining the level of impact based on an importance level associated with the given media device.

In at least one embodiment in accordance with any previous/other embodiment described herein, the origin of the media stream data is indicative of a geographic position of a given one of the one or more media devices having generated the media stream data, and the program instructions are executable by the processing unit for determining the level of impact based on an importance level associated with the geographic position of the given media device.

In at least one embodiment in accordance with any previous/other embodiment described herein, the content of the media stream data is indicative of a presence of at least one individual and/or asset at the location, and the program instructions are executable by the processing unit for determining the level of impact based on an importance level associated with the at least one individual and/or asset.

In at least one embodiment in accordance with any previous/other embodiment described herein, the program instructions are executable by the processing unit for increasing or decreasing at least one of the level of impact, the probability of investigation, and the at least one risk score in response to at least one of a user-initiated command and a system-initiated command.

In at least one embodiment in accordance with any previous/other embodiment described herein, the media stream data comprises a plurality of media stream segments each acquired over a given timeframe, and the program instructions are executable by the processing unit for assigning an individual risk score to each of the plurality of media stream segments.

In at least one embodiment in accordance with any previous/other embodiment described herein, the retention policy is indicative of at least one first action to be taken on the media stream data when the at least one risk score is greater than or equal to a threshold, and of at least one second action to be taken on the media stream data when the at least one risk score is lower than the threshold.

In at least one embodiment in accordance with any previous/other embodiment described herein, the retention policy is indicative of the at least one first action comprising storing an entirety of the media stream data in target storage media, and of the at least one second action comprising thinning the media stream data to retain at least one selected portion thereof and storing the at least one selected portion in the target storage media.

In at least one embodiment in accordance with any previous/other embodiment described herein, the retention policy is indicative of the at least one first action comprising processing the media stream data to increase a quality thereof and generate a high-quality media stream data, and storing the high-quality media stream data in target storage media, and of the at least one second action comprising processing the media stream data to reduce the quality thereof and generate a low-quality media stream data, and storing the low-quality media stream data in the target storage media.

In at least one embodiment in accordance with any previous/other embodiment described herein, the retention policy is indicative of at least one action to be taken on the media stream data prior to storage thereof, the at least one action comprising processing the media stream data to modify a quality thereof and generate a modified media stream data, and storing the modified media stream data in target storage media.

In at least one embodiment in accordance with any previous/other embodiment described herein, the retention policy is indicative of the at least one first action comprising causing the media stream data to be stored in target storage media for a first time period, and of the at least one second action comprising causing the media stream data to be stored in the target storage media for a second time period lower than the first time period.

In at least one embodiment in accordance with any previous/other embodiment described herein, the program instructions are executable by the processing unit for causing the media stream data to be stored in at least one of cloud-based storage media and local storage media over a predetermined time period.

In at least one embodiment in accordance with any previous/other embodiment described herein, the program instructions are executable by the processing unit for causing the media stream data to be stored in two or more different target storage media.

In at least one embodiment in accordance with any previous/other embodiment described herein, the media stream data comprises at least one of audio data, image data, video data, and text data.

Many further features and combinations thereof concerning embodiments described herein will appear to those skilled in the art following a reading of the instant disclosure.

### DESCRIPTION OF THE FIGURES

In the Figures,

FIG. 1 is a schematic diagram illustrating a system for media retention, in accordance with an illustrative embodiment;

FIG. 2 is a schematic diagram detailing a network and the cloud-based computing infrastructure of the system of FIG. 1, in accordance with an illustrative embodiment;

FIG. 3 is a schematic diagram of the media retention engine of FIG. 2, in accordance with an illustrative embodiment;

FIG. 4 is a flowchart illustrating an example method for media retention, in accordance with an illustrative embodiment; and FIG. 5 is block diagram of an example computing device, in accordance with an illustrative embodiment.

It will be noticed that throughout the appended drawings, like features are identified by like reference numerals.

### DETAILED DESCRIPTION

Described herein are methods and systems for media retention. In one embodiment, the systems and methods described herein may be used for monitoring and surveillance, and more specifically for retention of media stream data generated within an area monitoring system (also referred to herein as a “surveillance system”). It should however be understood that the methods and systems described herein may be used for a variety of applications and other embodiments may therefore apply.

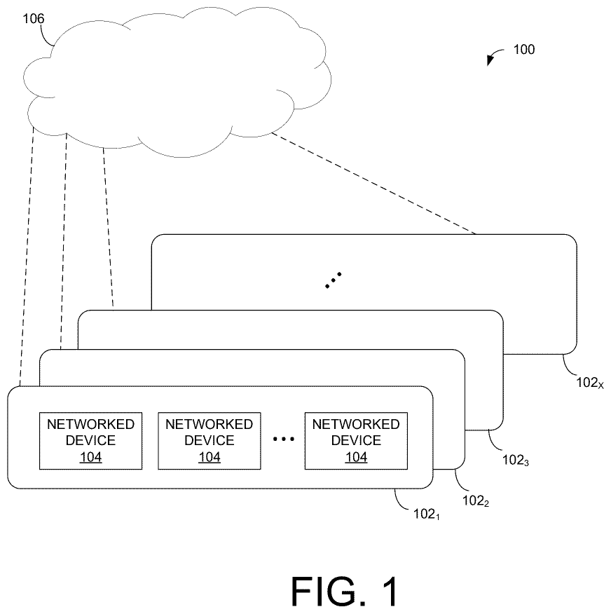

FIG. 1 illustrates an example system 100 for media retention. The system 100 may be a surveillance system. It should however be understood that, while reference is made herein to a system 100 used for security purposes, the system 100 may be used for any other suitable purpose, such as for monitoring public transport or traffic, etc. The system 100 may also be implemented in any suitable environment, such as, but not limited to, a home, a business, or the like.

The system 100 comprises a number (X) of local networks 102₁, 102₂, . . . , and 102_{X} each deployed at a location (or site) being surveilled. For instance, a first network 102₁ may be deployed at a first geographical location and a second network 102₂ may be deployed at a second geographical location different from the first geographical location. Any suitable number of networks 102₁, 102₂, . . . , 102_{X} may apply. In some embodiments, only one network as in 1021 is provided. In other embodiments, the system 100 is a distributed system comprising more than one network 102₁, 102₂, . . . , 102_{X}. Each network 102₁, 102₂, . . . , 102_{X} may comprise any suitable network including, but not limited to, a Personal Area Network (PAN), Local Area Network (LAN), Wireless Local Area Network (WLAN), Metropolitan Area Network (MAN), or Wide Area Network (WAN), or combinations thereof. In one embodiment, each network 102₁, 102₂, . . . , 102_{X} is a LAN having a plurality of networked devices 104 placed thereon. In addition, each network 102₁, 102₂, . . . , 102_{X} is communicatively coupled to a cloud-based computing infrastructure 106 which is configured to provide one or more cloud computing services to one or more components of the system 100, as will be described further below.

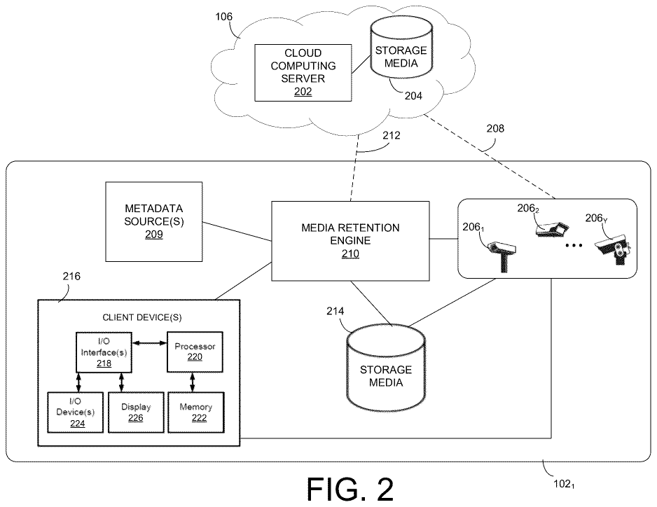

It should be understood that the system 100 may comprise a wide variety of different network technologies and protocols. Communication between the networked devices 104 may occur across wired, wireless, or a combination of wired and wireless networks. In addition to the networked devices 104 described below with reference to FIG. 2, the system 100 may include any number of devices such as routers, modems, bridges, hubs, switches, and/or repeaters, among other possibilities.

Referring now to FIG. 2 in addition to FIG. 1, in one embodiment, the cloud-based computing infrastructure 106 is configured to run part of the workload of components of the video surveillance system 100 in the cloud. In particular, the cloud-based computing infrastructure 106 may provide any suitable cloud computing service(s) related to management of the video surveillance system 100 including, but not limited to, processing of media stream data, cloud archiving or storage of media stream data, storage of video indexes, off-network live video requests and viewing, video analysis, indexing and persisting metadata for applications such as forensic search, live video camera health monitoring, alert scheduling, bandwidth management, or other form of processing and/or management related to the media stream data. For this purpose, in one embodiment, the cloud-based computing infrastructure 106 comprises a cloud computing device (referred to herein as a cloud computing server) 202 communicatively coupled to cloud-based storage media 204. The cloud computing server 202 may comprise one or more virtual processors configured to process the media stream data upon receipt thereof and cause the cloud computing service(s) to be provided.

Still referring to FIG. 2 in addition to FIG. 1, in one embodiment, the plurality of networked devices 104 comprises a plurality (Y) of media devices 206₁, 206₂, . . . , 206_{Y}. It should be understood that any suitable number of media devices may apply. In some embodiments, the plurality of media devices 206₁, 206₂, . . . , 206_{Y} may have direct network connectivity (i.e., are configured to directly connect, through the communication link 208) to the cloud-based computing infrastructure 106. In other embodiments, the plurality of media devices 206₁, 206₂, . . . , 206_{Y} may not be configured to have such direct network connectivity and may only access the cloud-based computing infrastructure 106 via one or more other networked devices 104 (e.g., via one or more gateway devices, not shown) to which they are connected.

The media devices 206₁, 206₂, . . . , 206_{Y} may be used to monitor objects, events, places, and/or people of interest within the location under surveillance. As a result of such monitoring, the media devices 206₁, 206₂, . . . , 206_{Y} generate media streams, which may include image and/or video data and/or audio data, all referred to herein as “media stream data”. Any media stream generated by the media devices 206₁, 206₂, . . . , 206_{Y} may comprise metadata, which might include, but is not limited to, an identifier associated with the media device 206₁, 206₂, . . . , 206_{Y} that generated the media stream, a timestamp, media content descriptors, auditing or integrity parameters, and the like. It should be understood that the media stream data generated by the media devices 206₁, 206₂, . . . , 206_{Y} may also comprise and/or have associated therewith text data indicative of various information including, but not limited to, transcripts, activity trails or records, entry/exit activity, badge sequences, measurements (e.g., temperature, pressure, or other measurements associated with relevant operating parameter(s) of the surveillance system 100), etc. In one embodiment, the media devices 206₁, 206₂, . . . , 206_{Y} comprise digital video cameras (e.g., fixed cameras, dome cameras, pan, tilt, and zoom-or PTZ-cameras, panoramic and multi-sensor cameras, and the like) disposed within the location under surveillance. Such video cameras may comprise Internet Protocol (IP) cameras configured to send the media stream data via the network 102₁, 102₂, . . . , 102_{X} they are placed in, which may, in this case, comprise an IP network. The media devices 206₁, 206₂, . . . , 206_{Y} may also (or alternatively) comprise any suitable surveillance device including, but not limited to, radars, audio microphones, video and/or audio encoders connected to analog device(s) or appliance(s), sensors, door stations, intercoms, and the like.

Furthermore, the media devices 206₁, 206₂, . . . , 206_{Y} may provide the media stream data in real-time or non-real time. The media devices 206₁, 206₂, . . . , 206_{Y} may comprise local storage (e.g., a local memory, not shown). In embodiments in which the media stream data is provided in non-real time, the media devices 206₁, 206₂, . . . , 206_{Y} may comprise devices, such as network-attached storage media having media stream data recorded therein. It should therefore be understood that while reference is made herein to the media 206₁, 206₂, . . . , 206_{Y} being video cameras, this is for illustrative purposes only and any other suitable media device may apply. It should also be understood that the group of media devices 206₁, 206₂, . . . , 206_{Y} may comprise devices of different types.

When the system 100 comprises several media devices 206₁, 206₂, . . . , 206_{Y}, these may be located in close proximity to one another, for instance in the same building or on the same city block, or they may be remote from one another, for instance, located in different parts of the same city or in different cities altogether. Embodiments involving clusters of media devices 206₁, 206₂, . . . , 206_{Y} may also be considered, where media devices 206₁, 206₂, . . . , 206_{Y} belonging to one of a number of clusters may be geographically proximate to one another while the clusters themselves may be remote from one another.

In one embodiment, the plurality of networked devices 104 comprises one or more metadata source(s) 209 configured to provide information about events occurring at the location being surveilled by the surveillance system 100. In one embodiment, the data provided by each metadata source 209 forms an events stream that informs the retention policy(ies) applied by the surveillance system 100 using the systems and methods described herein. In some embodiments, the data provided by the metadata source(s) 209 is not to be retained (i.e. stored) by the surveillance system 100, unlike the media stream data generated by the media devices 206₁, 206₂, . . . , 206_{Y}. The one or more metadata source(s) 209 include, but are not limited to, access control systems, point of sales systems, sensors, and any other suitable device or system. Although the metadata source(s) 209 are illustrated as being separate from the media devices 206₁, 206₂, . . . , 206_{Y}, it should be understood that the metadata source(s) 209 may, in some embodiment, comprise the media devices 206₁, 206₂, . . . , 206_{Y}. Indeed, the media devices 206₁, 206₂, . . . , 206_{Y} may also be configured to generate metadata information that is in turn used by the surveillance system 100 to inform the retention policy(ies) to be applied, as will be described further below. Although not shown, it should also be understood that other component(s) of the surveillance system 100 (such as client device(s) 216) may also be configured to generate metadata information.

Still referring to FIG. 2 in addition to FIG. 1, in one embodiment, the plurality of networked devices 104 further comprises a media retention engine 210 communicatively coupled to the media devices 206₁, 206₂, . . . , 206_{Y}. In the illustrated embodiment, the media retention engine 210 has direct connectivity to the cloud-based computing infrastructure 106 (e.g., via communication link 212) or indirect connectivity thereto (e.g., via one or more other networked devices 104). Although the media devices 206₁, 206₂, . . . , 206_{Y} and the media retention engine 210 are illustrated as being provided on the same (i.e. common) local network 1021, it may, in some embodiments, be suitable for the media retention engine 210 to be provided in the cloud-based computing infrastructure 106. It may also be suitable for the media retention engine 210 to be provided on a local network different from the local network 1021 on which the media devices 206₁, 206₂, . . . , 206_{Y} are provided. The media retention engine 210 may be provided at a centralizing location, such as at a local network different from the local network 1021 which manages a plurality of subnetworks.

In one embodiment, the media retention engine 210 is configured to determine the manner in which the media stream data generated by the media devices 206₁, 206₂, . . . , 206_{Y} is to be retained (i.e. stored or archived) within the system 100, for subsequent access, use and/or processing. In particular, and as will be described further below, the media retention engine 210 is configured to assign at least one retention policy to the media stream data and to cause the media stream data to be stored in target storage media according to the assigned retention policy. In some embodiments, the media retention engine 210 may be configured to determine (i.e. define) the retention policy dynamically, e.g., by computing a retention duration (or duration of storage) for the media stream data in real-time. In other embodiments, the media retention engine 210 may be configured to select the retention policy among multiple retention policies of the surveillance system.

The media retention engine 210 may cause the media stream data generated by the media device(s) 206₁, 206₂, . . . , 206_{Y} to be stored in the local memory of the media device(s) 206₁, 206₂, . . . , 206_{Y}, in storage media 214 provided on the local network 102₁ or on another network 102₂, 102₃, . . . , 102_{X}, and/or in the cloud-based computing infrastructure 106 (i.e. in the cloud-based storage media 204) in accordance with the retention policy. The cloud-based storage media 204 and the local storage media 214 may indeed each comprise a medium (i.e. a computer-readable medium) configured for storing data in a format readable by a processor or other computing device. The cloud-based storage media 204 and the storage media 214 may, in some embodiments, be one or more servers comprising one or more databases. In some embodiments, the media retention engine 210 is configured to instruct at least one of the media devices 206₁, 206₂, . . . , 206_{Y} on the manner in which the media stream data is to be stored.

Still referring to FIG. 2 in addition to FIG. 1, in one embodiment, the plurality of networked devices 104 further comprises client device(s) 216 in communication with the one or more media device(s) 206₁, 206₂, . . . , 206_{Y}, as well as with the media retention engine 210. One or more client devices 216 may be provided, in close proximity to one another, for instance located in the same office or data center, or remote from one another, for instance located in different offices and data centers dispersed across the same city or in different cities altogether. Each client device 216 may be a remote computing device (i.e. functioning as a client) that comprises a plurality of components interconnected via bus connections and the like. In the illustrated example, each client device 216 comprises I/O interface(s) 218, at least one processor 220, at least one memory 222, I/O device(s) 224 (e.g., a keyboard, a mouse, a touchscreen, etc.), and at least one display device 226 (e.g. a screen, a tactile display, etc.). The client device 216 may be a desktop computer, a laptop, a smartphone, a tablet, etc.

A client application program may be stored in the memory 222 of each client device 216, the client application program providing the user with an interface to interact with the media retention engine 210. In some embodiments, the media retention engine 210 may be connected to at least one client device 216, where, for instance, the connection between the media retention engine 210 and the client device 216 may be a wired connection. In some embodiments, the functionality of the media retention engine 210 and the client device 216 may be implemented on a single computing device.

The client device 216 may be operated by authorized user(s) to access, view, process, edit and/or analyze information associated with the media stream data generated by the media device(s) 206₁, 206₂, . . . , 206_{Y} and stored in the target storage media. The information may comprise video information, such as a video feed, as well as any other relevant information. The client device 216 may be configured to launch a video playback application, a web browser, or a web application (not shown) that renders a graphical user interface (GUI) on the display device 226. The GUI may be used to display outputs and accept inputs and/or commands from user(s) of the client device 216. The GUI may further provide user(s) with the ability to view and/or edit video feeds, as well as be presented information of interest related to the video feeds.

It is proposed herein to perform retention of the media stream data generated by the media devices 206₁, 206₂, . . . , 206_{Y} within the system 100 dynamically, based on one or more retention policies obtained by the media retention engine 210. The retention policies may vary depending on the configuration of the system 100 and each policy ensures retention (e.g., storage or archiving) of the media stream data in one or more target storage media associated with the system 100. The retention policies may be determined in order to achieve any desired objective in relation to the system 100. In one embodiment, the retention policies are set in order to optimize the costs of operating the surveillance system 100. It should however be understood that the retention policies may also be set in order to optimize network usage, system reliability, and resiliency to disconnection.

As used herein, the term “reliability”, when referring to the system 100, refers to the fact that one can depend (or rely) on the system 100 to operate as expected. For a video-surveillance system, such as the system 100, reliability may encompass several aspects including, but not limited to, ensuring that video is recorded and available at all times or ensuring proper management of the network bandwidth. As used herein, the term “resiliency to disconnection” refers to the fact that recording gaps in the media stream data are avoided even in the event of disconnection of the media device 206₁, 206₂, . . . , 206_{Y} generating the media stream data. For example, if a media device 206₁, 206₂,. 206_{Y} (e.g., a video camera) continuously streams data that is stored in the cloud-based storage media 204 and loses network (e.g., Internet) connectivity, recording gaps in the video archive can be avoided by relying on local storage provided at the local networks 102₁, 102₂, . . . , 102_{X}. In particular, the local storage (e.g., the storage media 214 or memory within the media devices 206₁, 206₂, . . . , 206_{Y}) may act as a buffer that allows for the system 100 to fill any gaps in cloud storage when network connectivity is restored.

In some embodiment, the policies are stored in memory (e.g., the local storage media 214) placed on the local network 1021 and may be directly obtained (i.e., retrieved) by the media retention engine 210. In other embodiments, the policies are stored in the cloud-based storage media 204 and may be retrieved by the media retention engine 210 via the cloud computing server 202. In particular, the media retention engine 210 may send a request to the cloud computing server 202, which may in turn retrieve the policies from the cloud-based storage media 204 and transmit the retrieved policies to the requesting entity.

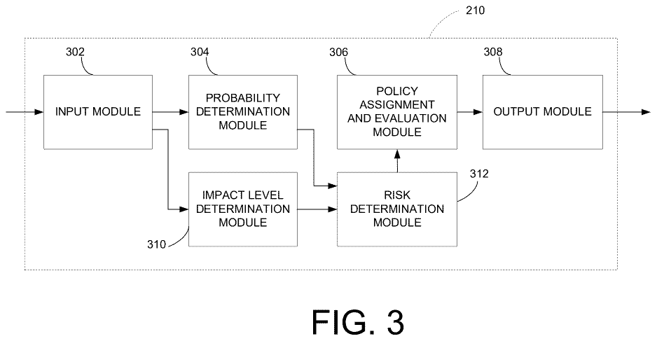

Referring now to FIG. 3 in addition to FIG. 2, in one embodiment, the media retention engine 210 comprises an input module 302, a probability determination module 304, a policy assignment and evaluation module 306, an output module 308. The media retention engine 210 may further comprise an impact level determination module 310 and a risk determination module 312.

The input module 302 is configured to receive input data from various components of the surveillance system 100. As such, the input data received by the input module 302 comprises, but is not limited to, the media stream data generated by the media devices 206₁, 206₂, . . . , 206_{Y}, data (e.g., commands, requests, or the like) received from a user via the client device(s) 216, metadata information from the metadata source(s) 209 (or any other suitable component of the surveillance system 100), and other relevant data obtained from one or more other components of the surveillance system 100. The input data is then sent from the input module 302 to the probability determination module 304, which is configured to determine a probability of an investigation employing (i.e. using) the media stream data in the event that one or more events occur at the location. As used herein, the term “probability of investigation” refers to the likelihood that the particulars of the one or more events having occurred at the location will be searched or examined into (e.g., to learn or ascertain facts related to the event(s), find evidence, identify suspect(s), etc.) using the media stream data. The probability of investigation may, in some embodiments, be quantitative and expressed in numerical terms, as a value from a range of values (e.g., a value on a scale from 0 to 10, a value on a percentage scale, etc.). The probability of investigation may, in other embodiments, be qualitative and expressed using a qualitative measure such as “low”, “moderate”, or “high”. For example, a probability greater than or equal to a predetermined threshold may be referred to as a “high probability”, whereas a probability lower than the threshold may be referred to as a “low probability”. Other embodiments may apply The probability determination module 304 is configured to determine and adjust (i.e. increase or decrease) the probability of investigation dynamically. In some embodiments, the probability of investigation may be set at a first value (also referred to herein as a “default probability”). For example, media stream data that is likely to be audited may be assigned a default high probability to ensure proper retention. By way of another example, media streams produced by different ones of the media devices 206₁, 206₂, . . . , 206_{Y} may be assigned different default probabilities depending on their location, the time at which the media streams were captured, the type or identity of the media device in question, or the like. The probability determination module 304 may then adjust the probability of investigation dynamically as new information is received by the surveillance system 100.

Adjustment of the probability of investigation (e.g., from the default value) may occur in response to a user-initiated command (e.g., provided by the user via the I/O device(s) 224 of their client device 216) and/or a system-initiated command (e.g., automatically generated by one or more components of the surveillance system 100) and may be performed in real-time or near real-time. The probability may be increased or decreased based on events or conditions at the location and/or within the surveillance system 100. Conditions at the location may be related to the parameter(s) associated with the location's environment, the local network 102₁ on which the media devices 206₁, 206₂, . . . , 206_{Y} are deployed, and/or the cloud-based infrastructure 106, as described above. For example, the probability determination module 304 may be configured to increase the probability of investigation in the event of failure of the local network 102₁ or of a system alert being triggered. Events resulting in an increase of the probability include, but are not limited to, abnormal events, active incidents, active threats, and the like. When an abnormal event occurs at the location, the probability of investigation grows, causing the need for retention of the media stream data to become more important. For example, the probability determination module 304 is configured to increase the probability of investigation in the event that a strike or protest occurs at the location. It should be understood that the probability of investigation may also be decreased based on or more events or conditions. For example, the absence of motion in a monitored location may result in the probability determination module 304 decreasing the probability of investigation for that location.

In some embodiments, the probability determination module 304 may determine the probability of investigation and/or detect the occurrence of the events (e.g., abnormal or disruptive events) requiring adjustment of the probability based on an analysis (referred to herein as a “media content analysis”) of the media stream data. The media content analysis may be performed using any suitable processing technique such as video analysis. The media content analysis described herein may be conducted to analyze the content present in the field of view of the media devices 206₁, 206₂, . . . , 206_{Y}. For example, the media content analysis may be used for object detection, weather recognition, and the like. Any suitable component of the surveillance system 100 (including one or more modules of the media retention engine 210) may conduct the media content analysis.

In some embodiments, conducting an analysis of the content of the media stream data may result in generation of metadata that may comprise, but is not limited to, metadata items about the media stream itself (e.g., data format, resolution, time of capture, location of capture, media device used for capture, and the like) and metadata items about the contents of the media stream, including metadata items relating the presence of object(s) in the media stream (e.g., object type, object color, object location in the field of view of the media device, object direction of movement, object speed of movement, and the like), metadata items relating to environmental factors visible in the media stream (e.g., weather type, lighting conditions, disaster elements, and the like), or other metadata items. Some metadata items may be used to derive other metadata items. For example, a succession of object location metadata items (i.e. successive locations of an object in the media device's field of view over a given period of time) may be used to determine the object's speed of movement. While reference is made herein to metadata being generated based on the media content analysis, it should be understood that the media devices 206₁, 206₂, . . . , 206_{Y} may (instead or additionally) be configured to directly provide metadata items to the media retention engine 210. In other words, some or all of the metadata items may be known to the source (i.e. the media device 206₁, 206₂, . . . , 206_{Y} that generates the media stream data) and produced thereat.

The objects may, for example, include vehicles having given attribute(s) (e.g., type, color, make, model, etc.) and/or being vehicles of interest (e.g., license plate identifier matches a hitlist). The objects may also include persons performing specific action(s), exhibiting specific behavior(s), fitting a given description, and/or having given attribute(s) such as physical characteristic(s) (e.g., height, hair color, eye color, etc.), physical appearance (e.g., type of clothing, color of clothing, type of shoes, colors of shoes, glasses, tattoos, scars, carried objects, and any other identifying mark), or the like. The objects may also include registered persons of interest (e.g., registered criminals). Other embodiments may apply.

The probability determination module 304 may then determine (and adjust) the probability of investigation based on an outcome of the media content analysis (e.g., using the metadata items). The probability of investigation may be adjusted in real-time (e.g., live and on the fly as the media stream data is generated by the media device(s) 206₁, 206₂, . . . , 206_{Y}) or in an asynchronous manner. For example, the probability of investigation may be set based on the number of objects present in the media devices'field of view. The number of objects may be determined using any suitable counting (e.g., people counting) or estimation technique. The probability of investigation may also be adjusted based on a comparison of the number of objects to a predetermined threshold. For example, the probability of investigation may be increased (e.g., from a default value) upon detection, based on the metadata items, that the number of objects present at the location at a given point in time exceeds the threshold (e.g., if a crowd exceeding the location's expected occupancy is detected in the field of view of the media devices 206₁, 206₂, . . . , 206_{Y}).

In addition, the probability of investigation may be adjusted (e.g., increased) if movement is detected in the media devices'field of view (i.e. upon detection of moving objects). The probability of investigation may also be adjusted based on a path or direction of travel of the objects present in the devices'field of view. For example, the probability of investigation may be increased if the metadata items are indicative that a vehicle is entering a parking lot at a given time, that an individual is entering a store through the exit rather than through the entrance, or that an individual is walking on a highway or other non-pedestrian road. The probability of investigation may further be adjusted based on a speed, acceleration, and/or direction of movement of the objects detected in the devices'field of view (e.g., increased based on the speed being beyond a speed threshold, direction of movement breeching a predefined perimeter or boundary, etc.). For this purpose, once moving objects are detected in the devices'field of view, the speed of the detected objects may be determined. For example, the probability of investigation may be increased upon detection of cars traveling above or below authorized speed limitations for a given location. Other embodiments for determining and/or adjusting the probability of investigation based on the media content analysis may apply.

Furthermore, the probability determination module 304 may detect the occurrence of events (e.g., abnormal events) requiring adjustment of the probability based on input data received (e.g., at the input module 302) from the surveillance system 100. For example, the surveillance system 100 may automatically activate an alarm or threat level upon receipt (e.g., from a user, via the client device(s) 216) of an indication of an abnormal or disruptive event (e.g., a critical geo-political situation or the like). This may in turn result in the probability determination module 304 increasing the probability of investigation for the monitored location(s). Using the client device(s) 216, an operator may also manually activate the alarm or threat level on the monitored location(s), which would cause the probability determination module 304 to increase the probability of investigation.

In some embodiments, increasing the probability of investigation of a fist monitored area (e.g., a location or part of a location) may cause the probability of investigation of one or more adjacent monitored areas to be automatically increased. This would be due to the fact that the media stream data generated at the one or more adjacent monitored areas is more likely to be needed if the first monitored area requires investigation. Similarly, decreasing the probability of investigation of the first monitored area may cause the probability of investigation of the adjacent monitored area(s) to be decreased. The probability determination module 304 may therefore cascade a change (e.g., an increase or decrease) in the probability of investigation from one monitored area to one or more adjacent monitored areas in order to ensure appropriate retention of the corresponding media stream data.

Still referring to FIG. 3, in some embodiments, in addition to determining the probability of investigation in relation to an event, the media retention engine 210 is configured to determine (using the impact level determination module 310), for every location monitored by the surveillance system 100, a level of impact on an organization (e.g., the organization that operates the surveillance system 100) in case of occurrence of the event at the location. The media retention engine 210 is then configured to compute (using the risk determination module 312) a risk score based on the impact and probability as determined and to use (at the policy assignment and evaluation module 306) the risk score as input to decide the applicable retention policy for the media stream data. For this purpose, the impact level determination module 310 may receive from the input module 302 input data comprising the media stream data and any relevant data (e.g., metadata information) obtained from one or more other components of the surveillance system 100. Based on the received input data, the impact level determination module 310 determines the level of impact on an organization in case of occurrence of the event at the location.

As used herein, the term “impact” refers to effect(s) or consequence(s) on the organization that can be expected to result from occurrence of the event. Different impact having different levels may be observed depending on the organization. For example, a disruptive event such as a security breach may result in one or more of a loss of organizational assets, a perturbation of organizational operations, a compromise of confidentiality (e.g., loss of personal privacy and proprietary information), a compromise of integrity due to information modification or destruction, etc. As used herein, the term “level of impact” or “impact level” thus refers to the magnitude of the effect(s) or consequence(s) on the organization. The level of impact may, in some embodiments, be quantitative and expressed as a value from a range of values (e.g., a value on a scale from 1 to 10, a value on a percentage scale, etc.). The level of impact may, in other embodiments, be qualitative and expressed using a qualitative measure such as “low”, “moderate”, “high”, “critical”, “non-critical”, etc.

The level of impact may be static or may vary in time. In particular, the impact level determination module 310 may be configured to adjust (i.e. increase or decrease) the level of impact. The adjustment may occur in response to a user-initiated command and/or a system-initiated command and may be performed dynamically and in real-time.

The level of impact may be determined (and adjusted) based one or more factors. Any suitable factor may be used. In some embodiments, the impact level determination module 310 is configured to determine the level of impact based on the content of the media stream data received from the input module 302. For this purpose, the impact level determination module 310 (or any other suitable component of the system 100) may be configured to perform a media content analysis to determine and analyze the content of the media stream data (e.g., as received from the input module 302). The impact level determination module 310 may then determine the level of impact based on an outcome of the media content analysis.

In some embodiments, the level of impact is correlated with the importance level associated with the location at which the event has occurred, where the greater the importance level, the higher the impact level. The importance level may be set at any suitable time (e.g., prior to deployment of the surveillance system 100 at one or monitored locations, during an initial setup phase of the surveillance system 100, as part of renovations or changes to the layout of the location being surveilled, or the like) and stored in memory. The importance level may be provided to the impact level determination module 310 via the input module 302. An importance level may be associated with each area (i.e. each location or parts of a location) monitored by the surveillance system 100 and some areas may be assigned a default importance level. For example, a first importance level may be assigned to a lobby of a building, and a second (higher) importance level may be assigned to a server room located in the building. As a result, an event occurring in the server room would have a greater impact level than an event occurring in the lobby.

It should however be understood that, instead of assigning an importance level to every monitored area, the importance level may be assigned to a single entity of the area. For instance, an importance level may also be assigned to each object (e.g., individual or asset) present at the location. The level of impact may then be determined (and dynamically adjusted) upon identifying (e.g., using an object detection algorithm, based on access control records available to or generated by the surveillance system 100, or the like) specific object(s) (and, in some embodiments, the number of object(s)) in the media devices'field of view, and based on the importance level associated with each object. For example, a visitor considered to be a very important person (VIP), such as a person of high social status, influence, or the like (e.g., a celebrity, head of state or government, politician, major business partner, high-level corporate officer, etc.), may be assigned a higher importance level than a regular (i.e. not VIP) visitor. Continuing with the previous example, the impact level associated with the event occurring in the lobby may be increased if it is determined, based on the media content analysis, that one or more VIP visitors are present in the lobby. In particular, the impact level may be dynamically adjusted when the VIP visitor(s) scan their access badge at the lobby: an access control system forming part of, or being coupled to, the surveillance system 100 may produce a record or other indication of the presence of the VIP visitor(s), which may result in the portions of the location being surveilled where the VIP visitor(s) are present being temporarily assigned a higher level of impact.

In other embodiments, the impact level determination module 310 may be configured to determine and/or adjust the level of impact based on the origin of the media stream data. As used herein, the term “origin” refers to the source of the media stream data, namely the identity, the IP address, and/or the geographic position (e.g., Global Positioning System, or GPS, coordinates) of a given media device 206₁, 206₂, . . . , 206_{Y} used to generate the media stream data. For example, the level of impact may be determined based on an importance level associated with the identity of the given media device and/or with its geographic position. In some embodiments, certain origin markers, such as an IP address, may serve as a proxy for other origin markers: for instance, a default configuration for a surveillance system may indicate that a media device with an IP address ending in 0.001 is associated with a view of an entrance of the location, an IP address ending in 0.002 is associated with an exit of the location, and the like.

In yet other embodiments, the impact level determination module 310 may be configured to determine and/or adjust the level of impact based one or more indicators received from the surveillance system 10, via the input module 302. Such indicators include, but are not limited to, access control reads, event schedules, usage factors, and the like, which may be generated or obtained by the surveillance system 100, for instance via an access control system, by a scheduling system, or the like. For example, through the usage of the surveillance system 100, the impact level determination module 310 may increase or decrease the level of impact. While locations being surveilled (or different areas of a monitored location) may be assigned the same importance level, these locations or areas may have different uses and usage levels, with some locations or areas being used more frequently than others for instance. The locations or areas that are used more may then have an increased level of impact associated therewith compared to the locations or areas that are used less. In addition, the level of impact may be adjusted based on indicators such as the time of day or period. For example, the level of impact may be increased at a certain time of day (e.g., in the evenings or during business hours) or decreased during off-peak periods (e.g., on the weekends), or the like. Other embodiments may apply.

Still referring to FIG. 3, the impact level is sent to the risk determination module 312, which also receives the probability of investigation from the probability determination module 304. The risk determination module 312 then computes, based on the probability of investigation and on the level of impact, a risk score that is assigned to the media stream data. As used herein, the term “risk” refers to an indication of the effects or outcome of an undesirable or adverse event occurring. The risk score is therefore indicative of the level of risk. In some embodiments, the risk score is determined as a function of the probability of investigation and the level of impact. For instance, the risk score is determined by computing the product of the level of impact and the probability of investigation. The risk score may be quantitative and expressed as a value from a range of values (e.g., a value on a scale from 0 to 10, a value on a percentage scale, etc.). In other embodiments, the risk score may be qualitative and expressed using a qualitative measure such as “low”, “moderate”, “high”, “critical”, “non-critical”, etc. For example, a risk score greater than or equal to a predetermined threshold may be referred to as a “high risk”, and a risk score lower than the threshold may be referred to as a “low risk”. Other embodiments may apply.

It should be understood that the media stream data may be delimited in any suitable manner. For example, a given media stream may comprise multiple media stream data, and any given media stream data may comprise multiple media stream segments. For example, the media stream data may comprise several video segments when video is continuously streamed by the media devices 206₁, 206₂, . . . , 206_{Y}. In embodiments where the media stream data comprises a plurality of media stream segments each acquired over a given timeframe, an individual risk score is assigned to each media stream segment. In other words, the individual risk score may be applicable for the given timeframe (i.e. to specific datapoints in a temporal fashion). For example, a media stream segment acquired over one timeframe may be assigned a low risk while a media stream segment acquired over another timeframe may be assigned a high risk.

In some embodiments, the risk score may be initially assigned a default (e.g., neutral or “0”) value and the risk determination module 312 is configured to adjust (i.e. increase or decrease) the risk score. The adjustment may occur in response to a user-initiated command and/or a system-initiated command and may be performed dynamically, asynchronously, and in real-time. For example, a user making an unsuccessful access attempt at a high security door may result in an increased risk being associated with media data relating to the high-security door. In some cases, the information from the access control system may be received asynchronously from the generation of the media data: for instance, the access control system may have a reporting delay of several seconds, several minutes, several hours, or the like. When the media retention engine 210 receives the relevant information from the access control system, the risk determination module 312 may update the risk score for the media data relating to the high-security door, resulting in the policy assignment and evaluation module 306 updating the retention policy for the media data.

It should be understood that the media retention engine 210 may be configured to dynamically adjust (i.e. increase or decrease) one or more of the probability of investigation, the level of impact, and the risk score in the manner described herein above. For example, a boardroom within an office being surveilled may be assigned a low risk by default. By using information from a scheduling system, the surveillance system may know at which times meetings are scheduled to take place in the boardroom, and may also know which persons will be present at the meetings. For a first meeting attended by regular employees, the risk level may be raised to a medium-low level (for instance by increasing the impact level); for a second meeting attended by high-ranking official of a client, the risk level may be raised to a high level (for instance by increasing both the probability of investigation and the impact level). During periods of time where the office is closed, the risk level may remain at the low default, but if motion or persons are detected in the media data captured in the boardroom, the probability of investigation may rise, as well as the impact level, resulting in increased risk. Other example are considered.

Still referring to FIG. 3, the policy assignment and evaluation module 306 is configured to determine the appropriate retention policy to be assigned to the media stream data. The retention policy is determined using the risk score as determined by the risk determination module 312. For this purpose, the risk score may be provided to the policy assignment and evaluation module 306 for use in determining the retention policy. In one embodiment, the policy assignment and evaluation module 306 is configured to determine (i.e. define) the retention policy dynamically and in real-time. For example, the policy assignment and evaluation module 306 may be configured to compute a duration of storage based on the risk score so that the media stream data is stored according for the computed duration. In another embodiment, the policy assignment and evaluation module 306 is configured to select the appropriate retention policy among a plurality of global retention policies. Using the risk score, it therefore becomes possible for an organization (e.g., the organization that operates the surveillance system 100) to determine the appropriate retention policy based on the level of risk the organization is willing to face.

As previously noted, the global retention policies applicable for the surveillance system 100 are illustratively stored in memory, using any suitable format. In one embodiment, a lookup table format may be used, which maps or correlates the retention policies with the risk score (and/or the probability of investigation and/or the level of impact). For example, a retention policy may be associated with each probability value and/or risk score. The policy assignment and evaluation module 306 may then be configured to query the memory using the risk score in order to retrieve from the lookup table the applicable retention policy that matches the risk score. In one embodiment, if more than one retention policy matches the risk score, a rule may be applied to determine which retention policy to use. Any suitable rule may be used to select among multiple matching retention policies. In one embodiment, the rule may indicate that the more conservative retention policy is to be used. In other embodiment, the rule may indicate that the least expensive retention policy (i.e. the one having the lower storage costs associated therewith) is to be used. Other embodiments may apply.

In some embodiments, the policy assignment and evaluation module 306 is configured to assign a retention policy to the media stream data as the media stream data is generated by the media devices 206₁, 206₂, . . . , 206_{Y}. In other embodiments, the media retention engine 210 is configured to dynamically update or change (e.g., using the policy assignment and evaluation module 306) a previously-assigned retention policy used to store (i.e. assigned to) media stream data (or a particular portion thereof), based on new information that the surveillance system 100 is made aware of after the media stream data is stored. In this case, the media retention engine 210 may be configured to obtain (e.g., at the input module 302) the new information about one or more events to which the stored media stream data relates and to determine (e.g., using the risk determination module 312), based on this new information, whether the risk score associated with the media stream data is to be adjusted (i.e. increased or decreased). If the risk score is adjusted (e.g., at the risk determination module 312) based on the new information, the policy assignment and evaluation module 306 is configured to assign a new retention policy (different from the previously-assigned retention policy) to the media stream data and the media stream data is caused to be stored according to the newly-assigned retention policy.

In some embodiments, the retention policy indicates one or more actions to be taken according to the risk score. In particular, the retention policy may indicate one or more first actions to be taken on the media stream data when the risk score is indicative of a high risk, and the retention policy may indicate one or more second actions to be taken on the media stream data when the risk score is indicative of a low risk. For example, the retention policy may require for an entirety of the media stream data (i.e. every bit of information) to be stored in the target storage media in case of a high risk and for portion(s) of the media stream data to be stored in case of a low risk. The portion(s) of the media stream data may be obtained as a result of thinning the media stream data to retain only part(s) (e.g., important part(s)) thereof. Any suitable thinning mechanism may be used. Another example is for the retention policy to require the quality of the media stream data to be increased (i.e. to keep as high of a resolution as possible) in case of a high risk and decreased in case of a low risk, and for the modified media stream data (i.e. the resulting high-quality or low-quality media stream data) to be stored in the target storage media. It should be understood that the retention policy may be indicative of any suitable processing (besides thinning and quality modification) to be performed on the media stream data according to the risk score, prior to storage thereof. Such processing may include, but is not limited to, video transcoding the media stream data, decoding the media stream data, re-encoding the media stream data, applying at least one overlay on the media stream data, applying a privacy mask on the media stream data, digitally signing the media stream data, encrypting the media stream data, and adding metadata to the media stream data (e.g., to indicate a time at which the media stream data was generated).

Depending on the risk score, the retention policy may specify the target storage media to be used. In one embodiment, different target storage media having associated therewith different cost, ease of access, and duration of storage (e.g., short term vs. long term) may be used. For example, in the event that the risk score is indicative of a low risk, the retention policy may require the media stream data to be stored in cold and low-cost storage because the media stream data might never be reviewed given its low risk. However, in the event that the risk score is indicative of a high risk, the retention policy may require the media stream data to be stored in hot storage (e.g., locally). As used herein, the term “cold storage” refers to storage media which is optimized for storing data that is not to be easily accessed and/or is infrequently accessed, as opposed to “hot storage” which is optimized for storing media stream data that is to be easily and/or frequently accessed.

As yet another example, the retention policy may indicate that the media stream data is to be stored in a redundant manner (using the same or different quality), i.e. in two or more different target storage media. The retention policy may for example indicate that the media stream data is to be stored in the cloud-based storage media 204 (or another remote data store), the local storage media 214, or both for redundant archiving. The retention policy may also indicate the time period (e.g., number of hours, days, months, etc.) for which the media stream data is to be archived. In some cases, a default storage duration may be stipulated by local ordinance or regulation, and longer storage durations may be applied by retention policy for higher risk media stream data. In some embodiments, a policy may indicate that, when the risk score is indicative of a high risk, the media stream data should remain available at all times or most (e.g., 99%) of the time. The retention policy may also require the media stream data to be stored in the target storage media for a shorter time period in case of a low risk and for a longer time period in case of a high risk.

It should be understood that the examples of policies provided herein are for the purpose of illustration and that other embodiments may apply, depending on the application.

After the applicable retention policy is determined by the retention policy assignment and evaluation module 306, the latter may evaluate the policy to determine the manner in which the media stream data is to be stored and to determine what other operations, if any, should be applied to the media data stream. For example, the retention policy assignment and evaluation module 306 may evaluate the retention policy to determine the target storage media in which the media stream data is to be stored or the storage duration. The retention policy assignment and evaluation module 306 then sends one or more output signals to the output module 308 to cause the media stream data to be stored according to the retention policy. The output signals may comprise instructions specifying the target storage media, the storage duration, and any other relevant storage instructions resulting from evaluation of the retention policy by the retention policy assignment and evaluation module 306.

In some embodiments, the media retention engine 210 may be configured to actively store the media stream data in the target storage media (e.g., in the local storage media 214, and/or in the cloud-based storage media 204 via communication link 212) in accordance with the retention policy. In other embodiments, the media retention engine 210 may be configured to instruct other component(s) of the system 100 to cause the media stream data to be stored in accordance with the retention policy. For example, the output module 308 may be configured to send one or more instructions to the media devices 206₁, 206₂, . . . , 206_{Y} to cause the latter to store the media stream data (e.g., in the media devices'memory, in the local storage media 214, and/or in the cloud-based storage media 204 via communication link 208).

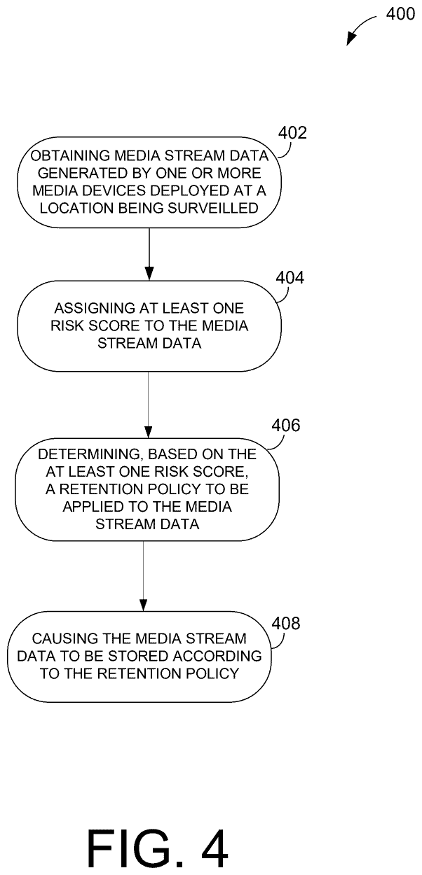

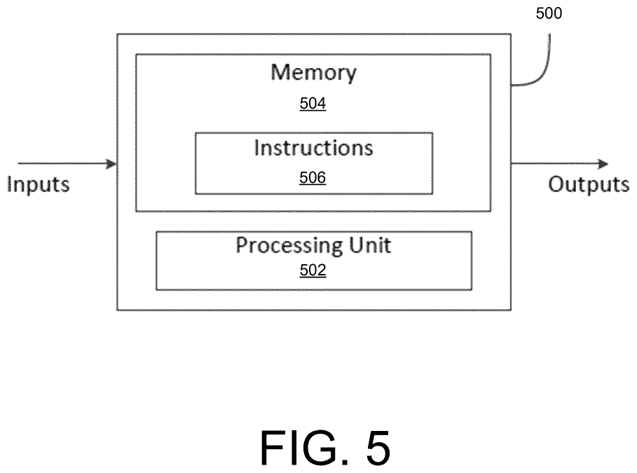

Referring now to FIG. 4, a method 400 for media retention in a surveillance system, such as the system 100 of FIG. 1, will now be described in accordance with one embodiment. The method 400 may be performed by the media retention engine 210 illustrated in FIG. 2 and FIG. 3. The method 400 comprises, at step 402, obtaining media stream data generated by one or more media devices (e.g., the media devices 206₁, 206₂, . . . , 206_{Y} of FIG. 2) deployed at a location being surveilled. The method 400 further comprises, at step 404, assigning at least one risk score to the media stream data (obtained at step 402). The at least one risk score may be determined in the manner described herein above with reference to FIG. 3, as a function of a probability of an investigation employing the media stream data and of a level of impact on the organization deploying the surveillance system upon occurrence of an event at the location being surveilled. The method 400 also comprises, at step 406, determining, based on the at least one risk score, a retention policy to be applied to the media stream data. As described herein above, the retention policy may be determined dynamically or selected among a plurality of retention policies (or global policies) of the surveillance system. The method 400 further comprises, at step 408, causing the media stream data to be stored according to the retention policy.

FIG. 5 is a schematic diagram of computing device 500, which may be used to implement one or more components of the system 100 of FIG. 1 and FIG. 2, such as the media retention engine 210, and/or to implement the method 400 of FIG. 4. In certain embodiments, the computing device 500 is operable to register and authenticate users (using a login, unique identifier, and password for example) prior to providing access to applications, a local network, network resources, other networks, and network security devices. The computing device 500 may serve one user or multiple users.

The computing device 500 comprises a processing unit 502 and a memory 504 which has stored therein computer-executable instructions 506. The processing unit 502 may comprise any suitable devices configured to implement the functionality of the method 400 such that instructions 506, when executed by the computing device 500 or other programmable apparatus, may cause the functions/acts/steps performed by method 400 as described herein to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitable programmed or programmable logic circuits, custom-designed analog and/or digital circuits, or any combination thereof. While in the example of FIG. 5, the processing unit 502 is shown as being unitary, the processing unit 502 may also be multicore, or distributed (e.g., a multi-processor).

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 504 may comprise any storage means (e.g. devices) suitable for retrievably storing machine-readable instructions 506 executable by the processing unit 502. The memory 504, though shown as unitary for simplicity in the example of FIG. 5, may comprise multiple memory modules and/or caching. In particular, the memory 504 may comprise several layers of memory such as a hard drive, external drive (e.g. SD card storage) or the like and a faster and smaller RAM module. The RAM module may store data and/or program code currently being, recently being or soon to be processed by the processing unit 502 as well as cache data and/or program code from a hard drive. A hard drive may store program code and be accessed to retrieve such code for execution by the processing device 502 and may be accessed by the processing device 502 to store and access data. The memory 504 may have a recycling architecture for storing, for instance, data source and/or database coordinates, where older data files are deleted when the memory 504 is full or near being full, or after the older data files have been stored in memory 504 for a certain time.

The memory 504 stores program instructions and data used by the processing unit 502 to implement the media retention functions described herein. The memory 504 may also store locally media stream data, acting as a local database, as well as store information regarding the media device(s) 206₁, 206₂, . . . , 206_{Y}. For example, the memory 504 may store the identity, IP address, and configuration (e.g., type, transmission capability, reception capability, etc.) of the media device(s) 206₁, 206₂, . . . , 206_{Y}.

In some embodiments, the systems and methods for data retention in a surveillance system described herein may allow to only retain media stream data (generated by media devices forming part of the surveillance system) when needed. The systems and methods described herein may further allow to use retention policies for dynamic data retention, based on input received from the surveillance system in real-time. The methods and systems described herein may therefore assist operators of the surveillance system 100 in better managing costs, storage requirements, and infrastructure. In some cases, employing the methods and systems described herein may further result in reduced data loss and/or improved data availability at any given time. Furthermore, using the systems and methods describes herein may allow for risk management to be user configurable such that a user or operator of the surveillance system 100 may decide the manner in which to deal with the risk associated with the media stream data. Risk management may also be done at a high level, where the user may only be setting risk considerations with no detailed management of the retention policy(ies) by the user. The systems and methods described herein may additionally facilitate respecting regulations or ordinances about retention.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references have been made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments. The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the examples described above and illustrated herein are intended to be examples only, and the appended claims are intended to include within their scope such processes, machines, manufacture, compositions of matter, means, methods, or steps.

1. A method for media retention in a surveillance system deployed by an organization at a location being surveilled, the method comprising:
obtaining media stream data generated by one or more media devices deployed at the location;
assigning at least one risk score to the media stream data;
determining, based on the at least one risk score, a retention policy to be applied to the media stream data; and
causing the media stream data to be stored according to the retention policy.

2. The method of claim 1, wherein the surveillance system has a plurality of retention policies associated therewith, and further wherein determining the retention policy comprises selecting the retention policy among the plurality of retention policies based on the at least one risk score.

3. The method of claim 1, wherein the retention policy is determined dynamically based on the at least one risk score.

4. The method of claim to 3, further comprising determining a probability of an investigation employing the media stream data upon occurrence of at least one event at the location.

5. The method of claim 4, further comprising determining a level of impact on the organization upon the occurrence of the at least one event at the location.

6. The method of claim 5, wherein the at least one risk score is determined as a function of the level of impact and the probability of the investigation.

7. The method of claim 1, wherein the media stream data was previously caused to be stored according to a previously-assigned retention policy, further wherein the retention policy assigned to the media stream data based on the at least one risk score is different from the previously-assigned retention policy.

8. The method of claim 5, further comprising processing the media stream data for determining a content thereof, wherein the level of impact is determined based on the content of the media stream data.

9. The method of claim 5, further comprising processing the media stream data for identifying an origin thereof, wherein the level of impact is determined based on the origin of the media stream data.

10. The method of claim 5, further comprising receiving one or more indicators from the surveillance system, wherein the level of impact is determined based on the one or more indicators.

11. The method of claim 9, wherein the origin of the media stream data is indicative of a given one of the one or more media devices having generated the media stream data, further wherein the level of impact is determined based on an importance level associated with the given media device.

12. The method of claim 9, wherein the origin of the media stream data is indicative of a geographic position of a given one of the one or more media devices having generated the media stream data, further wherein the level of impact is determined based on an importance level associated with the geographic position of the given media device.

13. The method of claim 8, wherein the content of the media stream data is indicative of a presence of at least one individual and/or asset at the location, further wherein the level of impact is determined based on an importance level associated with the at least one individual and/or asset.

14. The method of claim 6, further comprising increasing or decreasing at least one of the level of impact, the probability of investigation, and the at least one risk score in response to at least one of a user-initiated command and a system-initiated command.

15. The method of claim 1, wherein the media stream data comprises a plurality of media stream segments each acquired over a given timeframe, and further wherein an individual risk score is assigned to each of the plurality of media stream segments.

16. The method of claim wherein the retention policy is indicative of at least one first action to be taken on the media stream data when the at least one risk score is greater than or equal to a threshold, and of at least one second action to be taken on the media stream data when the at least one risk score is lower than the threshold.

17. The method of claim 16, wherein the retention policy is indicative of the at least one first action comprising storing an entirety of the media stream data in target storage media, and of the at least one second action comprising thinning the media stream data to retain at least one selected portion thereof and storing the at least one selected portion in the target storage media.

18. The method of claim 16, wherein the retention policy is indicative of the at least one first action comprising processing the media stream data to increase a quality thereof and generate a high-quality media stream data, and storing the high-quality media stream data in target storage media, and of the at least one second action comprising processing the media stream data to reduce the quality thereof and generate a low-quality media stream data, and storing the low-quality media stream data in the target storage media.

19. The method of claim 1, wherein the retention policy is indicative of at least one action to be taken on the media stream data prior to storage thereof, the at least one action comprising processing the media stream data to modify a quality thereof and generate a modified media stream data, and storing the modified media stream data in target storage media.

20. The method of claim 16, wherein the retention policy is indicative of the at least one first action comprising causing the media stream data to be stored in target storage media for a first time period, and of the at least one second action comprising causing the media stream data to be stored in the target storage media for a second time period lower than the first time period.

21. The method of claim 1, wherein the media stream data is caused to be stored in at least one of cloud-based storage media and local storage media over a predetermined time period.

22. The method of claim 1, wherein the media stream data is caused to be stored in two or more different target storage media.

23. The method of claim 1, wherein the media stream data comprises at least one of audio data, image data, video data, and text data.

24. A system for media retention in a surveillance system deployed by an organization at a location being surveilled, the system comprising:
a processing unit; and
a non-transitory computer-readable medium having stored thereon program instructions executable by the processing unit for:
obtaining media stream data generated by one or more media devices deployed at the location;
assigning at least one risk score to the media stream data;
determining, based on the at least one risk score, a retention policy to be applied to the media stream data; and
causing the media stream data to be stored according to the retention policy.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
